(19) United States
(12) Patent Application Publication
(10) Pub. No.: US 2008/0150177 A1
(43) Pub. Date: Jun. 26, 2008

(54) SURFACE TREATMENT OF FLUORINATED OPHTHALMIC DEVICES

(75) Inventors: Daniel J. Hook, Fairport, NY (US); Daniel M. Ammon, Penfield, NY (US); Joseph C. Salamone, Boca Raton, FL (US)

Correspondence Address: Bausch & Lomb Incorporated, One Bausch & Lomb Place, Rochester, NY, 14604-2701, US

(73) Assignee: BAUSCH & LOMB INCORPORATED, Rochester, NY (US)

(21) Appl. No.: 11/613,360

(22) Filed: Dec. 20, 2006

(51) Int. Cl. B29C 59/14; B29D 11/00

(52) U.S. Cl. 264/1.36

(57) ABSTRACT

A method for treating a surface of a fluorinated silicone-containing ophthalmic device is provided, the method comprising plasma treating the fluorinated silicone-containing ophthalmic device with a hydrogen-containing atmosphere in the presence of an oxidizing source thereby increasing the wettability and/or biocompatibility of the device.

### BACKGROUND OF THE INVENTION

1. Technical Field

The present invention generally relates to a method for surface treating fluorinated silicone-containing ophthalmic devices.

2. Description of Related Art

Ophthalmic devices such as contact lenses made from fluorinated materials have been investigated for a number of years. Such materials can generally be subdivided into two major classes, namely hydrogels and non-hydrogels. Hydrogels can absorb and retain water in an equilibrium state whereas non-hydrogels do not absorb appreciable amounts of water. Regardless of their water content, both non-hydrogel and hydrogel fluorinated contact lenses tend to have relatively hydrophobic, non-wettable surfaces.

The art has recognized that introducing fluorine-containing groups into contact lens polymers can significantly increase oxygen permeability. For example, U.S. Pat. No. 4,996,275 discloses using a mixture of comonomers including the fluorinated compound bis(1,1,1,−3,3,3-hexafluoro-2-propyl)itaconate in combination with organosiloxane components. U.S. Pat. Nos. 4,954,587; 5,010,141 and 5,079,319 disclose that fluorination of certain monomers used in the formation of silicone hydrogels has been indicated to reduce the accumulation of deposits on contact lenses made from such materials. Moreover, the use of silicone-containing monomers having certain fluorinated side groups, i.e., —(CF₂)—H, have been found to improve compatibility between the hydrophilic and silicone-containing monomeric units. See, e.g., U.S. Pat. Nos. 5,321,108 and 5,387,662. Other fluorinated contact lens materials have been disclosed, for example, in U.S. Pat. Nos. 3,389,012; 3,962,279; and 4,818,801.

Those skilled in the art have recognized the need for modifying the surface of fluorinated contact lenses so that they are compatible with the eye. It is known that increased hydrophilicity of a contact-lens surface improves the wettability of the contact lenses. This, in turn, is associated with improved wear comfort of the contact lens. Additionally, the surface chemistry of the lens can affect the lens's susceptibility to deposition, particularly the deposition of proteins and lipids from the tear fluid during lens wear. Accumulated deposition can cause eye discomfort or even inflammation. In the case of extended-wear lenses, the surface is especially important, since extended-wear lenses must be designed for high standards of comfort over an extended period of time, without requiring daily removal of the lenses before sleep. Thus, the regimen for the use of extended-wear lenses would not provide a daily period of time for the eye to rest or recover from any discomfort or other possible adverse effects of lens wear during the day.

Contact lenses have been subjected to plasma surface treatment to improve their surface properties, with the intent to render their surfaces more hydrophilic, deposit resistant, scratch resistant, or otherwise modified. For example, plasma treatment to effect better adherence of a subsequent coating is generally known. U.S. Pat. No. 4,217,038 (“the '038 patent”) discloses, prior to coating a silicone lens with sputtered silica glass, etching the surface of the lens with an oxygen plasma to improve the adherence of a subsequent coating. U.S. Pat. No. 4,096,315 (“the '315 patent”) discloses a three-step method for coating plastic substrates such as lenses, preferably poly(methylmethacrylate) (PMMA) lenses. The method disclosed in the '315 patent involves (a) a first plasma treatment of the substrate to form hydroxyl groups on the substrate in order to allow for good adherence, (b) a second plasma treatment to form a silicon-containing coating on the substrate, and (c) a third plasma treatment with inert gas, air, oxygen, or nitrogen. The '315 patent states that pretreatment with hydrogen, oxygen, air or water vapor, the latter being preferred, forms hydroxy groups. Neither the '038 patent nor the '315 patent disclose the surface treatment of fluorinated contact lens materials in particular.

U.S. Pat. No. 4,312,575 (“the '575 patent”) discloses the use of hydrogen/fluorocarbon gaseous mixtures to treat silicone lenses. In Example 2 of the '575 patent, polydimethylsiloxane lenses are initially treated with a 50% hydrogen/50% tetrafluoroethylene mixture, followed by an oxygen plasma treatment. The '575 patent further discloses that when it is desired to utilize a halogenated hydrocarbon to perform the plasma polymerization process, hydrogen gas may be added to the halogenated hydrocarbon in order to accelerate the polymerization reaction. In particular, the '575 patent states that hydrogen may be added to the plasma polymerization apparatus in an amount ranging from about 0.1 to about 5.0 volumes of hydrogen per volume of the halogenated hydrocarbon. However, the '575 patent does not disclose how to surface treat fluorinated materials such as flourosilicone hydrogel or highly fluorinated contact lens materials.

U.S. Pat. No. 4,631,435 discloses a plasma polymerization process employing a gas containing at least one compound selected from halogenated alkanes, alkanes, hydrogen and halogens in specific combinations, the atomic ratio of halogen/hydrogen in the aforesaid gas being 0.1 to 5 and the electron temperature of the plasma in the reaction zone being 6,000° K to 30,000° K. The resulting coating is, in particular, suitable as the protective film for magnetic recording media.

U.S. Pat. Nos. 4,565,083; 5,034,265; 5,091,204; and 5,153,072 disclose a method of treating articles to improve their biocompatibility according to which a substrate material is positioned within a reactor vessel and exposed to plasma gas discharge in the presence of an atmosphere of an inert gas such as argon and then in the presence of an organic gas such as a halocarbon or halohydrocarbon gas capable of forming a thin, biocompatible surface covalently bonded to the surface of the substrate. The method is particularly useful for the treatment of vascular graft materials. The graft material is subjected to plasma gas discharge at 5-100 watts energy. Each of these patents does not discuss the surface treatment of a fluorinated contact lens materials.

U.S. Pat. No. 6,550,915 (“the '915 patent”) discloses a two step method of treating a fluorinated contact lens which includes (a) treating the polymer surface of the lens with a hydrogen-containing plasma to reduce the fluorine or C—F bonding content of the lens; and (b) plasma treating the reduced polymer surface with an oxidizing gas to increase its oxygen or nitrogen content.

In view of the above, it would be desirable to provide an improved method for surface treating a fluorinated silicone-containing ophthalmic device to provide an ophthalmic device with an optically clear, hydrophilic surface film that will exhibit improved wettability and biocompatibility which can be made in a convenient and cost efficient manner. It would also be desirable to be able to surface treat a fluorinated hydrogel or non-hydrogel ophthalmic lens that would allow its use in the human eye for an extended period of time.

### SUMMARY OF THE INVENTION

In accordance with one embodiment of the present invention, a method for treating a surface of a fluorinated silicone-containing ophthalmic device is provided comprising plasma treating the fluorinated silicone-containing ophthalmic device with a hydrogen-containing atmosphere in the presence of an oxidizing source, thereby increasing the wettability and/or biocompatibility of the ophthalmic device.

In accordance with a second embodiment of the present invention, a method for treating a surface of a fluorinated silicone-containing ophthalmic device is provided comprising plasma treating the fluorinated silicone-containing ophthalmic device with a hydrogen-containing atmosphere in the presence of an oxidizing source to reduce the fluorine content by at least 25 percent over the first 74 angstroms (Å) of the surface as determined by x-ray photoelectron spectroscopy (XPS) analysis and provide reactive functionalities in place thereof; and thereby increasing the wettability and/or biocompatibility of the ophthalmic device.

The method of the present invention is a one step method which combines a hydrogen plasma treatment with an oxidation surface treatment of a fluorinated silicone-containing ophthalmic device to cause the loss of fluorination and/or C—F bonding while oxidizing the surface of ophthalmic device to improve the wettability and/or biocompatibility of the device. The gaseous mixture will advantageously defluorinate the surface of the fluorinated silicone-containing ophthalmic device while at the same time add reactive functionalities to the surface of the device. Accordingly, the method of the present invention can be carried out in a more time effective manner while also being more economical.

### DETAILED DESCRIPTION OF THE PREFERRED EMBODIMENTS

The present invention is directed to a one step surface treatment method of a fluorinated silicone-containing ophthalmic device. As used herein, the term “ophthalmic device” refers to devices that reside in or on the eye. These devices can provide optical correction, wound care, drug delivery, diagnostic functionality or cosmetic enhancement or effect or a combination of these properties. Useful fluorinated silicone-containing ophthalmic devices include fluorinated silicone-containing ophthalmic lenses such as soft contact lenses, e.g., a soft, hydrogel lens; soft, non-hydrogel lens and the like, hard contact lenses, e.g., a hard, gas permeable lens material and the like, intraocular lenses, overlay lenses, ocular inserts, optical inserts and the like. As is understood by one skilled in the art, a lens is considered to be “soft” if it can be folded back upon itself without breaking.

A hydrogen plasma treatment combined with an oxidation treatment of a fluorinated silicone-containing ophthalmic device has advantageously been found to cause the loss of fluorination and/or C—F bonding while oxidizing the surface of the device. Without wishing to be bound by theory, since the plasma gas-phase reactions on the surface of a material are complex, it is believed that typically the hydrogen of a hydrogen-gas-containing plasma reacts with fluorine at the surface of the device, forming HF which can be carried off by a vacuum or mechanical pump during the process, thereby reducing fluorinated surface chemistries. At the same time, the oxidizing source, e.g., methanol, reacts with the defluorinated sites at the surface to form reactive functionalities that can, if desired, be covalently attached to other monomers in subsequent reactions, e.g., solution phase reactions. For example, methanol can form reactive hydroxyl groups at the defluorinated sites on the surface of the material.

In the case of fluorosilicone materials, the HF formed in the gas phase can be utilized to attack the silicone backbone of the polymer. The fluorine is believed to chemically react with the silicon atoms in the film, thereby forming SiFₓ species. When such a species has four fluorine atoms (SiF₄), the molecule can be pumped off by the vacuum, causing the loss of silicon from the film. At the same time, the large excess in hydrogen molecules causes the addition of hydrogen to the remaining chemistry, the hydrogen further reducing the surface of the lens material. The hydrogen-reduced surface of the lens can then be further modified by the use of simultaneous oxidizing treatments.

The process conditions of the present invention may be substantially the same as those in conventional plasma polymerization. The degree of vacuum during plasma polymerization may be about 1×10⁻³ to 1 torr and the flow rate of the gas flowing into the reactor may be, for example, about 0.1 to about 300 cc (STP)/min in the case of the reactor having an inner volume of about 100 liter. The above-mentioned hydrogen gas may be mixed with an inert gas such as argon, helium, xenon, neon or the like before or after being charged into the reactor with the oxidizing source. The addition of halogenated alkanes is unnecessary but not deleterious, and may be present in combination with the hydrogen, preferably at an atomic ratio of less than ten percent of gaseous halogen to hydrogen. The substrate temperature during plasma polymerization is not particularly limited, but is preferably between about 0° C. to about 300° C.

The type of discharge to be used for the generation of plasma is not particularly limited and may involve the use of DC discharge, low frequency discharge, high frequency discharge, corona discharge or microwave discharge. Also, the reaction device to be used for the plasma polymerization is not particularly limited. Therefore, either an internal electrode system or an electrodeless system may be utilized. There is also no limitation with respect to the shape of the electrodes or coil, or to the structure or the cavity or antenna in the case of microwave discharge. Any suitable device for plasma polymerization, including known or conventional devices, can be utilized.

Preferably, the plasma is produced by passing an electrical discharge, usually at radio frequency, through a gas at low pressure (about 0.005 to about 5.0 torr). Accordingly, the applied radio frequency power is absorbed by atoms and molecules in the gaseous state, and a circulating electrical field causes these excited atoms and molecules to collide with one another as well as the walls of the chamber and the surface of the material being treated. Electrical discharges produce ultraviolet (UV) radiation, in addition to energetic electrons and ions, atoms (ground and excited states), molecules and radicals. Thus, a plasma is a complex mixture of atoms and molecules in both ground and excited states which reach a steady state after the discharge is begun.

The effects of changing pressure and discharge power on the plasma treatment is generally known to the skilled artisan. The rate constant for plasma modification generally decreases as the pressure is increased. Thus, as pressure increases the value of E/P, the ratio of the electric field strength sustaining the plasma to the gas pressure, decreases and causes a decrease in the average electron energy. The decrease in electron energy in turn causes a reduction in the rate coefficient of all electron-molecule collision processes. A further consequence of an increase in pressure is a decrease in electron density. Taken together, the effect of an increase in pressure is to cause the rate coefficient to decrease. Providing that the pressure is held constant there should be a linear relationship between electron density and power. Thus, the rate coefficient should increase linearly with power.

Hydrogen plasmas have been found to reduce fluorination by attacking C—F bonds and forming C—H bonds. In the present invention, the surface chemistry of the fluorinated material is reduced to allow for the oxidizing source to react with the defluorinated sites at the surface to form reactive functionalities thereon. Such a preliminary reduction was found necessary, in order to reduce or eliminate the delamination of the oxidized surface. While investigating the dynamics of the hydrogen plasma with fluorinated substrates, it was further discovered that the silicone backbone in fluorosilicone materials could be removed by action of the plasma. As mentioned above, it is believed that the hydrogen gas forms HF gas which attacks the silicone backbone, and this is believed to convert much or most of the polymer backbone at the surface to aliphatic carbon species, thus tending to increase the carbon content of the surface. The carbon formed contains a fair amount of stereoregularity, and this carbon structure has lattice vibrations similar to graphite, although some unsaturation was also detected through the use of X-ray Photoelectron Spectroscopy (XPS). A substantial part of the original C—F bonding can be removed by the hydrogen plasma modification followed by the reaction of the defluorinated sites with the oxidizing source to form reactive functionalities on the surface. By the term “C—F bonding” is meant the total C—F bonding, whether in, for example, —CF, —CF₂ or —CF₃ groups.

Thus, the fluorine or C—F bonding content can be reduced to a level sufficient to allow reactive functionalities to be attached to the surface and subsequent layers to be formed, e.g., a reduction in fluorine by at least about 25 percent, preferably at least about 50 percent, and most preferably at least about 75 percent, over the first about 74 Å of the surface as determined by XPS analysis. The present invention also covers a contact lens, which when in the unhydrated state as is the condition of XPS analysis, has a surface coating characterized by a fluorine or C—F bonding content within a depth of about 74 Å that is at least about 25 percent, preferably at least about 50 percent, depleted relative to the bulk material.

At the same time, the surface of the hydrogen-plasma-treated silicone-containing ophthalmic device is treated by an oxidizing source, to increase its wettability and provide chemical functionalities (reactive sites) for subsequent coating steps. Generally, plasma oxidization is accomplished employing any suitable oxidizing source capable of being vaporized. Suitable oxidizing sources include inorganic and/or organic oxidizing sources. In one embodiment, an oxidizing source is an oxygen, sulfur and/or nitrogen-containing plasma. Representative examples of an oxidizing source include, but are not limited to, plasma gas containing ammonia, air, water, peroxide, O₂ (oxygen gas), alcohols, e.g., methanol and the like, ketones, e.g., acetone and the like, alkylamines, as well as other gases such as sulfur dioxide, sulfur oxide, phophorus monoxide, phophorus dioxide, carbon monoxide, carbon dioxide, nitric oxide, nitric dioxide and combinations thereof. As one skilled in the art will readily appreciate, the oxidizing source will form a film or layer over the surface of the device after the surface has been defluorinated. Depending on the particular type of oxidizing source used, the film or layer can be, for example, grafted or plasma polymerized on the surface of the device.

As previously stated, the hydrogen plasma treatment of a fluorinated silicone-containing ophthalmic device has been found to cause the loss of fluorination and/or C—F bonding over a surface depth of approximately 74 Å into the material. Accordingly, the oxidization of the surface can result in an increase in the nitrogen, sulfur and/or oxygen content by at least about 5 percent over the first about 74 Å of the surface as determined by XPS analysis, before further processing of the device such as extraction or heat sterilization. The present invention also covers a contact lens, which when in the unhydrated state as is the condition of XPS analysis, has a surface coating characterized by an oxygen content within a depth of about 74 Å that is at least about 2 mole percent enriched relative to the bulk material, based on XPS analysis.

The invention is applicable to a wide variety of fluorinated silicone-containing ophthalmic devices. The fluorine content in the top about 74 Å of the surface, before or after treatment according to the present invention, can be measured by XPS analysis. See, for example, C. D. Wagner, W. M. Riggs, L. E. Davis, J. F. Moulder, Handbook of X-ray Photoelectron Spectroscopy, Perkin-Elmer Physical Electronics Division, 6509 Flying Cloud Drive, Eden Prairie, Minn., 1978; D. M. Hercules, S. H. Hercules, “Analytical Chemistry of Surfaces, Part II. Electron Spectroscopy,” Journal of Chemical Education, 61, 6, 483, 1984; D. M. Hercules, S. H. Hercules, “Analytical Chemistry of Surfaces,” Journal of Chemical Education, 61, 5, 402, 1984, which are all hereby incorporated by reference. The determination of the depth of the analysis is based on the following equation:

(KE)=hν−BE−Φ

wherein hν=1486.6 eV (electron Volts) is the energy of the photon (e.g., the x-ray energy of the Al anode), KE is the kinetic energy of the emitted electrons detected by the spectrometer in the XPS analysis, and .phi. is the work function of the spectrometer. BE is the binding energy of an atomic orbital from which the electron originates and is particular for an element and the orbital of that element. For example, the binding energy of carbon (aliphatic carbon or CHₓ) is 285.0 eV and the binding energy of fluorine (in a C—F bond) is 689.6 eV. Furthermore,

(KE)^{1/2}=λ

δ=3λ sin θ

wherein θ is the takeoff angle of the XPS measurement (e.g., 45°), δ is the depth sampled (about 74 Å, as in the examples below), and λ is the mean free path or escape depth of an electron. As a rule of thumb, λ is utilized to estimate sampling depth since this accounts for about 95% of the signal originating from the sample.

As indicated above, the method of the present invention is applicable to fluorinated silicone-containing ophthalmic devices and is especially advantageous for the treatment of a fluorinated silicone-containing ophthalmic lens such as fluorosilicone hydrogels and non-hydrogels made from highly fluorinated polymers. In general, hydrogels are a well-known class of materials which comprise hydrated, cross-linked polymeric systems containing water in an equilibrium state. Non-hydrogels include elastomers and no-water or low-water xerogels. Fluorosilicone hydrogels generally have a water content greater than about 5 weight percent and more commonly between about 10 to about 80 weight percent. Fluorosilicone hydrogels (i.e., the bulk polymeric material from which it is comprised) generally contains up to about 20 mole percent fluorine atoms and as low as about 1 mole percent fluorine atoms, which to some extent may become enriched near the surface, depending on the manufacturing process such as the hydrophobicity of the lens mold.

In one embodiment, the polymer material can contain about 5 to about 15 mole percent fluorine atoms, wherein the mole percents are based on the amounts and structural formula of the components in bulk of the fluorinated polymer making up the contact lens. Such materials are usually prepared by polymerizing a mixture containing at least one fluorinated silicone-containing monomer and at least one hydrophilic monomer. Typically, either the fluorosilicone monomer or the hydrophilic monomer functions as a crosslinking agent (a crosslinker being defined as a monomer having multiple polymerizable functionalities), or a separate crosslinker may be employed. Applicable fluorosilicone monomeric units for use in the formation of contact-lens hydrogels are well known in the art and numerous examples are provided in commonly assigned U.S. Pat. Nos. 4,810,764 and 5,321,108, the contents of which are incorporated by reference herein. Also applicable are the fluorinated materials (e.g., B-1 to B-14) disclosed in U.S. Pat. No. 5,760,100.

The fluorinated polysiloxane-containing monomers disclosed in U.S. Pat. No. 5,321,108 are highly soluble in various hydrophilic compounds, such as N-vinyl pyrrolidone (NVP) and N,N-dimethyl acrylamide (DMA), without the need for additional compatibilizers or solubilizers.

As used herein, the term “side group” refers to any chain branching from a siloxane group, and may be a side chain when the siloxane is in the backbone of the polymeric structure. When the siloxane group is not in the backbone, the fluorinated strand or chain which branches out from the siloxane group becomes a side chain off of the siloxane side chain.

The “terminal” carbon atom refers to the carbon atom located at a position furthest from the siloxane group to which the fluorinated strand, or side group is attached.

When the polar fluorinated group, —(CF₂)_{z}H, is placed at the end of a side group attached to a siloxane-containing monomer, the entire siloxane monomer to which the side group is attached is rendered highly soluble in hydrophilic monomers, such as NVP. When the hydrogen atom in the terminal fluorinated carbon atom is replaced with a fluoro group, the siloxane-containing monomer is significantly less soluble, or not soluble at all in the hydrophilic monomer present.

Fluorinated siloxane-containing monomers useful in the present invention include those having at least one fluorinated side group, the side group having the general formula I:

-D-(CF₂)_{z}H (I)

wherein z is 1 to 20; and D is an alkyl or alkylene group having 1 to about 10 carbon atoms and which may have ether linkages between the carbon atoms.

Polymeric materials useful in the method of the present invention may also be polymerized from monomer mixtures containing at least fluorinated siloxane-containing monomers having at least one fluorinated side group and having a moiety of the following general formula II:

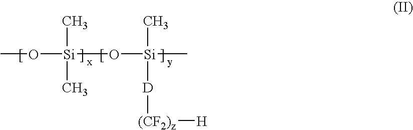

wherein D is an alkyl or alkylene group having 1 to about 10 carbon atoms and which may have ether linkages between carbon atoms; x>0; y>1; x+y=2 to 1000; and z is 1 to 20. A preferred material for use herein is a polymeric material prepared from monomer mixtures containing fluorinated siloxane-containing monomers having the following general formula III:

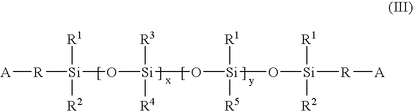

wherein R is an alkyl or alkylene group having 1 to about 10 carbon atoms and which may have ether linkages between carbon atoms; R¹—R⁴ may independently be a monovalent hydrocarbon radical or a halogen substituted monovalent hydrocarbon radical having 1 to about 18 carbon atoms which may have ether linkages between carbon atoms; x>0; y>1; x+y=2 to 1000; and z is 1 to 20; and R⁵ is independently a fluorinated side chain having the general formula:

-D-(CF₂)_{z}—H

wherein z is 1 to 20; D is an alkyl or alkylene group having 1 to about 10 carbon atoms and which may have ether linkages between carbon atoms; and A is independently an activated unsaturated group, such as an ester or amide of an acrylic or a methacrylic acid, a styryl group, or is a group represented by the general formula:

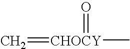

wherein Y is —O—, —S— or —NH—.

Preferably, the fluorinated side group is represented by the formula:

—CH₂—CH₂—CH₂—O—CH₂—(CF₂)_{z}—H

Where z is 1 to 20. One preferred fluorinated siloxane-containing monomer, is prepared according to the following reaction scheme:

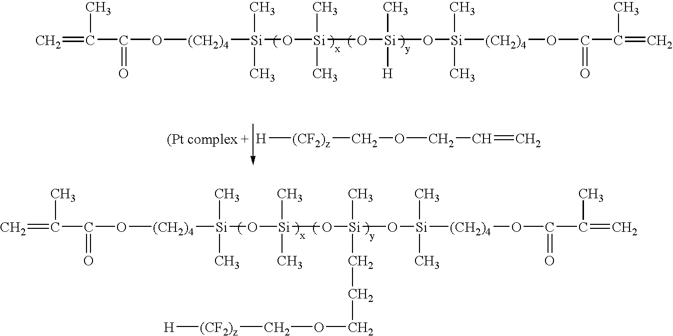

wherein y is 10, 25 and 40; x+y is 100; and z is 4 or 6.

In another embodiment, the fluorinated siloxane-containing monomers are fluorinated bulky polysiloxanylalkyl(meth)acrylate monomers represented by the general formula:

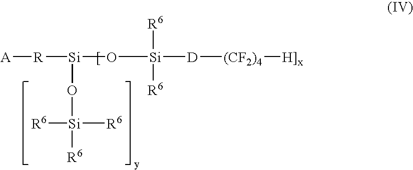

wherein A is an activated unsaturated group, such as an ester or amide of an acrylic or a methacrylic acid or a styryl group; R⁶ is independently CH₃ or H; R is an alkyl or alkylene group having 1 to about 10 carbon atoms and which may have ether linkages between the carbon atoms; D is independently an alkyl or alkylene group having 1 to about 10 carbon atoms and which may have ether linkages between carbon atoms; x is 1, 2 or 3; y is 0, 1, or 2; and x+y=3.

In another embodiment, fluorinated bulky polysiloxanylalkyl monomers for use herein can be represented by the general formula:

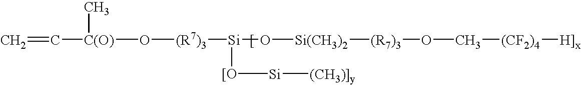

wherein R⁷ is CH₂; and x is 1, 2 or 3; y is 0, 1 or 2; and x+y=3.

Another class of fluorinated materials that can be surface treated by the method of the present invention is highly fluorinated non-hydrogel materials. Highly fluorinated polymer materials have at least about 10 mole percent fluorine atoms, preferably about 20 to about 70 mole percent fluorine, again based on the amounts and structural formulae of the components of the polymer. Such materials include, for example, high-Dk fluoropolymeric rigid-gas-permeable contact-lens articles made from material containing at least perfluorinated monomers. An especially advantageous (high-Dk) material includes an amorphous copolymer of perfluoro-2,2-dimethyl-1,3-dioxole (PDD) with one or more copolymerizably acceptable ethylenically unsaturated fluorinated comonomers, the proportion of perfluoro-2,2-dimethyl-1,3-dioxole in the copolymer being at least about 20 mole percent of the copolymer. The latter material may further include from about 10 to about 80 weight percent of one or more other comonomers such as, for example, tetrafluoroethylene, hexafluoropropylene, chlorotrifluoroethylene (CTFE), vinylidene fluoride, perfluoro(alkyl vinyl)ether (PAVE) having the formula CF₂—CFO(CF₂ CFXO)ₙ R_{f} wherein X is independently F or CF₃, n is 0-5, and R_{f} is a perfluoroalkyl group of 1 to about 6 carbon atoms, and mixtures thereof. Another class of highly fluorinated non-hydrogel materials is xerogels or elastomers, an example of which is disclosed in commonly assigned U.S. Pat. No. 5,714,557.

Other hydrogel and non-hydrogel materials may be prepared from a monomeric mixture including at least one or more fluorinated silicone-containing monomers. Suitable fluorinated silicone-containing monomers include fluorosilicone monomers such as, for example, fluoroalkyl(meth)acrylates, fluorosiliconeitaconates and the like and combinations thereof.

In practice, fluorinated silicone-containing ophthalmic devices such as contact lenses may be surface treated by placing them, in their unhydrated state, within an electric glow discharge reaction vessel (e.g., a vacuum chamber). Such reaction vessels are commercially available. The lenses may be supported within the vessel on an aluminum tray (which acts as an electrode) or with other support devices designed to adjust the position of the lenses. The use of specialized support devices which permit the surface treatment of both sides of a lens are known in the art and may be used in the present invention.

The plasma treatment, for example, hydrogen or hydrogen in an inert gas such as argon, and an oxidizing source may suitably utilize an electric discharge frequency of, for example, 13.56 MHz, suitably between about 100 to about 1000 watts, preferably about 200 to about 800 watts, more preferably about 300 to about 500 watts, at a pressure of about 0.1 to about 1.0 torr. In one embodiment, the fluorinated silicone-containing ophthalmic device is plasma treated with a mixture of at least a hydrogen-containing atmosphere and oxidizing source. In another embodiment, the fluorinated silicone-containing ophthalmic device is plasma treated simultaneously with the hydrogen-containing atmosphere and oxidizing source. The plasma-treatment time is a time period sufficient to form the oxidized layer on the surface of the device and is within the purview of one skilled in the art, e.g., a time period of at least a few seconds. Optionally, the lens may be flipped over to better treat both sides of the lens. The plasma-treatment gas is suitably provided at a flow rate of about 50 to about 500 sccm (standard cubic centimeters per minute), more preferably about 100 to about 300 sccm. The thickness of the surface treatment is sensitive to plasma flow rate and chamber temperature, as will be understood by the skilled artisan. Since the coating is dependent on a number of variables, the optimal variables for obtaining the desired or optimal coating may require some adjustment. If one parameter is adjusted, a compensatory adjustment of one or more other parameters may be appropriate, so that some routine trial and error experiments and iterations thereof may be necessary in order to achieve the coating according to the present invention. However, such adjustment of process parameters, in light of the present disclosure and the state of the art in plasma treatment, should not involve undue experimentation. As indicated above, general relationships among process parameters are known by the skilled artisan, and the art of plasma treatment has become well developed in recent years.

Following the formation of the oxidized layer having chemical or reactive functionalities on the surface of the device, further surface treatments can be carried out. For example, a biocompatible material can be reacted with the chemical or reactive functionalities. Suitable biocompatible materials include, but are not limited to, hydrophilic polymers (including macromonomers and oligomers) as disclosed in the prior art. The attachment of polymers to chemical or reactive functionalities on the surface of the device and suitable polymers are disclosed in, for example, U.S. Pat. No. 6,630,243. Other patents or literature references teaching the attachment of hydrophilic polymers to the functionalized surface of a material will be known to the skilled artisan. Attachment of the biocompatible material with the chemical or reactive functionalities can be via covalent bonding, ionic bonding, hydrogen bonding, hydrophobic association and the like.

It will be understood that various modifications may be made to the embodiments disclosed herein. Therefore the above description should not be construed as limiting, but merely as exemplifications of preferred embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the features and advantages appended hereto.

What is claimed is:

1. A method for treating a surface of a fluorinated silicone-containing ophthalmic device, the method comprising plasma treating the fluorinated silicone-containing ophthalmic device with a hydrogen-containing atmosphere in the presence of an oxidizing source, thereby increasing the wettability and/or biocompatibility of the ophthalmic device.

2. The method of claim 1, wherein the fluorinated silicone-containing ophthalmic device is a fluorinated silicone-containing ophthalmic lens.

3. The method of claim 1, wherein the fluorinated silicone-containing ophthalmic device is a fluorinated silicone-containing contact lens.

4. The method of claim 1, wherein the fluorine content is reduced by at least about 25 percent over the first 74 angstroms (Å) of the surface as determined by x-ray photoelectron spectroscopy (XPS) analysis.

5. The method of claim 1, wherein the fluorine content is reduced by at least about 75 percent over the first 74 Å of the surface as determined by XPS analysis.

6. The method of claim 1, wherein the fluorinated silicone-containing ophthalmic device is a polymerization product of a monomeric mixture comprising a fluorine-containing silicone monomer.

7. The method of claim 6, wherein the monomer is a poly(organosiloxane) capped with an unsaturated group at two ends containing a fluorinated side group.

8. The method of claim 7, wherein the monomer contains a pendant fluorinated alkyl group containing a —CF₂— group or a —CHF₂ or —CF₃ end group.

9. The method of claim 7, wherein the monomer comprises a fluorinated derivative of a polysiloxanylalkyl(meth)acrylate monomer.

10. The method of claim 6, wherein the monomeric mixture further comprises a non-siloxy, fluorine-containing monomer.

11. The method of claim 1, wherein the oxidizing source comprises an inorganic material.

12. The method of claim 1, wherein the oxidizing source comprises an organic material.

13. The method of claim 1, wherein the oxidizing source comprises a nitrogen, oxygen and/or sulfur-containing oxidizing gas.

14. The method of claim 1, wherein the oxidizing source is selected from the group consisting of ammonia, air, water, peroxide, O₂ (oxygen gas), alcohol, ketone, alkylamine, sulfur dioxide, sulfur oxide, phophorus monoxide, phophorus dioxide, carbon monoxide, carbon dioxide, nitric oxide, nitric dioxide and combinations thereof.

15. A method for treating a surface of a fluorinated silicone-containing ophthalmic device, the method comprising plasma treating the fluorinated silicone-containing ophthalmic device with a hydrogen-containing atmosphere in the presence of an oxidizing source, to reduce the fluorine content by at least 25 percent over the first 74 Å of the surface as determined by XPS analysis and provide reactive functionalities in place thereof; and thereby increasing the wettability and/or biocompatibility of the device.

16. The method of claim 15, wherein the fluorinated silicone-containing ophthalmic device is a fluorinated silicone-containing ophthalmic lens.

17. The method of claim 15, wherein the fluorinated silicone-containing ophthalmic device is a fluorinated silicone-containing contact lens.

18. The method of claim 15, further comprising reacting a biocompatible material with the reactive functionalities on the surface of the device.

19. The method of claim 15, further comprising reacting a hydrophilic polymer with the reactive functionalities on the surface of the device.

20. The method of claim 15, wherein the reactive functionalities are covalently attached to a biocompatible material.
